(19) United States
(12) Patent Application Publication
(10) Pub. No.: US 2011/0278120 A1
(43) Pub. Date: Nov. 17, 2011

(54) WEAR RESISTANT TRANSPORTATION SYSTEMS, METHODS, AND APPARATUS

(75) Inventors: Roger W. Kaufold, Pittsburgh, PA (US); Thomas J. Kasun, Export, PA (US); Neville C. Whittle, Irwin, PA (US)

(73) Assignee: Alcoa Inc., Pittsburgh, PA (US)

(21) Appl. No.: 12/781,664

(22) Filed: May 17, 2010

(51) Int. Cl. B60M 1/30; B05D 5/12

(52) U.S. Cl. 191/22 R; 427/58

(57) ABSTRACT

The present disclosure relates to wear resistant transportation systems, methods, and apparatus. In one embodiment, a system includes a contact device, a conductor bar, and a mobile unit. The contact device is coupled to the mobile unit and in electrical communication with both the conductor bar and the mobile unit. The contact device is configured to travel across, and is in contact with, the conductor bar coincidental to movement of the mobile unit. A thin, conductive wear resistant coating is located on an outer surface of at least one of the conductor bar and contact device. The thin, conductive wear resistant coating restricts abrading of the outer surface of at least one of the conductor bar and the contact device.

### BACKGROUND

Transportation systems may include conductor bars and contact devices. Conductor bars and contact devices can be used in a variety of applications. For example, a conductor bar can be used as a third rail for railway transportation, in amusement parks and with cranes, hoists, and people movers, to name a few. A contact device typically travels across and is in contact with the conductor bar and may be coupled to a mobile unit. The conductor bar and/or the contact device may experience wear as the contact device travels across and is in contact with the conductor bar due to movement of the mobile unit.

### SUMMARY OF THE DISCLOSURE

The present disclosure relates to wear resistant transportation systems, methods, and apparatus. In one aspect, these wear resistant transportation systems, methods, and apparatus include a mobile unit configured to move from a first location to a second location, a conductor bar, and a contact device coupled to the mobile unit and in electrical communication with both the conductor bar and the mobile unit. The contact device may be configured to travel across, and is in contact with, the conductor bar coincidental to movement of the mobile unit. A thin, conductive wear resistant coating is located on an outer surface of at least one of the conductor bar and the contact device. The thin, conductive wear resistant coating restricts abrading of the outer surface of at least one of the conductor bar and the contact device while maintaining electrical conductivity between the conductor bar, contact device and mobile unit.

As noted above, various components of the system are in electrical communication with one another. Electrical communication means to transmit electric current between entities. For example, a conductor bar may transmit electric current to a mobile unit via a contact device. In one embodiment, the conductor bar supplies electric current to the contact device. In one embodiment, the contact device collects electric current from the conductor bar. In one embodiment, the contact device supplies electric current to the mobile unit. Electric current means the flow of electrically charged particles in a medium between two points having a difference in electrical potential. For example, current may flow from a conductor bar to a mobile unit via a contact device.

The use of these thin, conductive wear resistant coatings may facilitate improved abrasion resistance and thus less maintenance of the transportation system. In one embodiment, the thin, conductive wear resistant coating limits direct physical contact between the outer surface of the conductor bar and the contact device. In one embodiment, the thin, conductive wear resistant coating is located on an outer surface of the conductor bar and limits wear of the outer surface of the conductor bar (e.g., removal of a portion of the outer surface of the conductor bar) due to movement of the contact device as the contact device travels across the outer surface of the conductor bar. In one embodiment, the thin, conductive wear resistant coating is located on an outer surface of the contact device and limits wear of the outer surface of the contact device (e.g., removal of a portion of the outer surface of the contact device) due to movement of the contact device as the contact device travels across the outer surface of the conductor bar.

The thin, conductive wear resistant coating may facilitate improved electrical conductivity in the transportation system. In one embodiment, the thin, conductive wear resistant coating has a resistivity of not greater than about 30×10⁻⁶ Ω*in/in². In one embodiment, the thin, conductive wear resistant coating has a thickness of not greater than about 0.040 inch. In one embodiment, the conductor bar having a thin, conductive wear resistant coating on at least a portion of its outer surface has a surface roughness from about 12 u-inch Rₐ to about 50 u-inch Rₐ. In one embodiment, the conductor bar having a thin, conductive wear resistant coating on at least a portion of its outer surface has a surface flatness of not greater than about 0.002 inch. In one embodiment, the conductor bar having a thin, conductive wear resistant coating on at least a portion of its outer surface has an electrical resistance of not greater than 30 uΩ. In one embodiment, the conductor bar having a thin, conductive wear resistant coating on at least a portion of its outer surface has a coefficient of thermal expansion of not greater than about 23 in/in/° F. at a temperature from about 68° F. to about 212° F.

In one embodiment, the thin, conductive wear resistant coating sustains arcing due to intermittent contact between the contact device and the conductor bar as the contact device travels across the outer surface of the conductor bar. In one embodiment, the thin, conductive wear resistant coating comprises at least one of stainless steel and copper.

In one embodiment, a conductor bar may be configured to supply electric current to a mobile unit via a contact device. The contact device may be configured to travel across, and is in contact with, the conductor bar coincidental to movement of the mobile unit. A thin, conductive wear resistant coating is located on an outer surface of the conductor bar. The thin, conductive wear resistant coating restricts the contact device from abrading the outer surface of the conductor bar. In one embodiment, the thin, conductive wear resistant coating limits direct physical contact between the outer surface of the conductor bar and the contact device. In one embodiment, the thin, conductive wear resistant coating comprises at least one of stainless steel and copper. In one embodiment, the thin, conductive wear resistant coating has a thickness of not greater than about 0.040 inch.

In another aspect, methods of producing wear resistant transportation systems are provided. In one embodiment, a method includes the steps of applying a thin, conductive wear resistant coating to an outer surface of at least one of a conductor bar precursor and a contact device, forming the conductor bar precursor into a conductor bar, moving the contact device across the conductor bar coincidental to the movement of a mobile unit from a first location to a second location, and passing current through the contact device and into the mobile unit. During the moving step and passing step, the thin, conductive wear resistant coating restricts abrading of the outer surface of at least one of the conductor bar and the contact device. In one embodiment, the thin, conductive wear resistant coating is located on the outer surface of the conductor bar. In one embodiment, the thin, conductive wear resistant coating is crack-free before the forming step. In one embodiment, the thin, conductive wear resistant coating is crack-free after the forming step.

Various ones of the inventive aspects noted hereinabove may be combined to yield various wear resistant transportation systems, methods, and apparatus. These and other aspects, advantages, and novel features of the invention are set forth in part in the description that follows and will become apparent to those skilled in the art upon examination of the following description and figures, or may be learned by practicing the invention.

### BRIEF DESCRIPTION OF THE DRAWINGS

FIG. 1 is a schematic view of one embodiment of a wear resistant transportation system useful in accordance with the present disclosure.

FIG. 2 is a perspective view illustrating one embodiment of a conductor bar and contact device used with a mobile unit.

FIG. 3 is a schematic view of one embodiment of a wear resistant transportation system useful in accordance with the present disclosure.

FIG. 4 is a perspective view illustrating one embodiment of a conductor bar and contact device used with a mobile unit.

FIG. 5 is a schematic view of one embodiment of a wear resistant transportation system useful in accordance with the present disclosure.

FIG. 6 is a flow chart of one embodiment of methods useful in producing wear resistant transportation systems.

### DETAILED DESCRIPTION

Reference will now be made in detail to the accompanying drawings, which at least assist in illustrating various pertinent embodiments of the present invention.

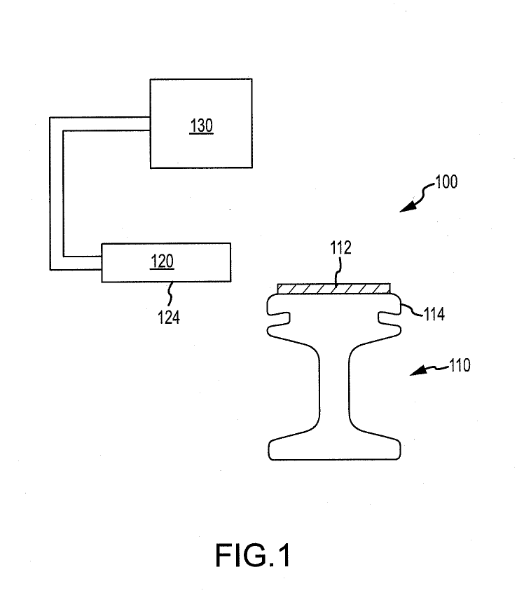

One embodiment of a wear resistant transportation system useful in accordance with the present invention is illustrated in FIG. 1. In the illustrated embodiment, the system 100 includes a conductor bar 110, a contact device 120, and a mobile unit 130. A thin, conductive wear resistant coating 112 is located on an outer surface 114 of the conductor bar 110. The contact device 120 may be coupled to the mobile unit 130 and is in electrical communication with both the mobile unit 130 and the conductor bar 110. The contact device 120 may be configured to travel across, and is in contact with, the conductor bar 110 coincidental to movement of the mobile unit 130. For example, as the mobile unit 130 moves, the outer surface 124 of the contact device 120 is in contact with the thin, conductive wear resistant coating 112 of the conductor bar 110. The thin, conductive wear resistant coating 112 facilitates efficiency of electric current transmission from the conductor bar 110 to the mobile unit 130, lighter weight and reduced thickness of the conductor bar 110, and prevents wear of the conductor bar 110 such that, the conductor bar 110 achieves a longer use than without the thin, conductive wear resistant coating 112, resulting in less maintenance of the system 100.

As noted above, the thin, conductive wear resistant coating 112 restricts abrading of the outer surface 114 of the conductor bar 110. In one embodiment, the thin, conductive wear resistant coating 112 limits or prevents wear of the outer surface 114 of the conductor bar 110 (e.g., removal of a portion of the outer surface 114 of the conductor bar 110) due to the movement of the contact device 120, as the contact device 120 travels across the outer surface 114 of the conductor bar 110. In one embodiment, the thin, conductive wear resistant coating 112 limits or prevents direct physical contact between the contact device 120 and the outer surface 114 of the conductor bar 110.

To achieve efficient electric current transmission, the thin, conductive wear resistant coating may have a low resistivity. In one embodiment, the thin, conductive wear resistant coating 112 has a resistivity of not greater than about 30×10⁻⁶ Ω*in/in². In some embodiments, the thin, conductive wear resistant coating 112 has a resistivity of not greater than about 29.5×10⁻⁶ Ω*in/in², or not greater than about 29×10⁻⁶ Ω*in/in², or not greater than about 28.5×10⁻⁶ Ω*in/in², or not greater than about 28×10⁻⁶ Ω*in/in². In one embodiment, the conductor bar 110 having a thin, conductive wear resistant coating 112 on at least a portion of its outer surface 114 has an electrical resistance of not greater than about 30μΩ.

To achieve reduced thickness of the conductor bar 110, the thin, wear resistant coating 112 may have a relatively low thickness. In one embodiment, the thin, conductive wear resistant coating 112 has a thickness of not greater than about 0.04 inch. In some embodiments, the thin, conductive wear resistant coating 112 has a thickness of not greater than about 0.035 inch, or not greater than about 0.03 inch, or not greater than about 0.025 inch, or not greater than about 0.02 inch, or not greater than about 0.015 inch, or not greater than about 0.01 inch. In one embodiment, the thin, conductive wear resistant coating 112 comprises at least one of stainless steel and copper.

To achieve wear resistance, among other things, the conductor bar 110 having a thin, conductive wear resistant coating 112 on at least a portion of its outer surface 114 may have a relatively low surface roughness measured in any direction along the surface. In one embodiment, the conductor bar 110 having a thin, conductive wear resistant coating 112 on at least a portion of its outer surface 114 has a surface roughness of not greater than about 50μ-inch Rₐ. In some embodiments, the conductor bar 110 having a thin, conductive wear resistant coating 112 on at least a portion of its outer surface 114 has a surface roughness of not greater than about 40μ-inch Rₐ, or not greater than about 35μ-inch Rₐ, or not greater than about 30μ-inch Rₐ, or not greater than about 25μ-inch Rₐ, or not greater than about 20μ-inch Rₐ, or not greater than about 15μ-inch Rₐ, or not greater than about 12μ-inch Rₐ. In one embodiment, the conductor bar 110 having a thin, conductive wear resistant coating 112 on at least a portion of its outer surface 114 has a surface roughness in the range from about 12μ-inch Rₐ to about 50μ-inch Rₐ. In one embodiment, the conductor bar 110 having a thin, conductive wear resistant coating 112 on at least a portion of its outer surface 114 has a surface flatness of not greater than about 0.002 inch.

The achieve wear resistance, among other things, the conductor bar 110 having a thin, conductive wear resistant coating 112 on at least a portion of its outer surface 114 may generally have an average coefficient of thermal expansion of about 13 in/in/° F. at a temperature from about 68° F. to about 212° F. In one embodiment, the conductor bar 110 having a thin, conductive wear resistant coating 112 on at least a portion of its outer surface 114 has an average coefficient of thermal expansion of not greater than about 23 in/in/° F. at a temperature from about 68° F. to about 212° F. In some embodiments, the conductor bar 110 having a thin, conductive wear resistant coating 112 on at least a portion of its outer surface 114 has an average coefficient of thermal expansion of not greater than about 20 in/in/° F., or not greater than about 17 in/in/° F., or not greater than about 14 in/in/° F., or not greater than about 11 in/in/° F., or not greater than about 8 in/in/° F., or not greater than about 5 in/in/° F., or not greater than about 3 in/in/° F., at a temperature from about 68° F. to about 212° F. In one embodiment, the conductor bar 110 having a thin, conductive wear resistant coating 112 on at least a portion of its outer surface 114 has an average coefficient of thermal expansion in the range from about 3 in/in/° F. to about 23 in/in/° F. at a temperature from about 68° F. to about 212° F.

In one embodiment, the thin, conductive wear resistant coating 112 sustains arcing due to intermittent contact between the contact device 120 and the conductor bar 110 as the contact device 120 travels across the outer surface 114 of the conductor bar 110. For example, in some instances, the contact device 120 loses contact with the conductor bar 110, causing a continuous electric discharge between the contact device 120 and the conductor bar 110. This continuous electric discharge results in very high temperatures that can cause damage (e.g., melting) to the conductor bar 110 and/or the contact device 120. The thin, conductive wear resistant coating 112 may limit or prevent melting of the conductor bar 110 and/or contact device 120.

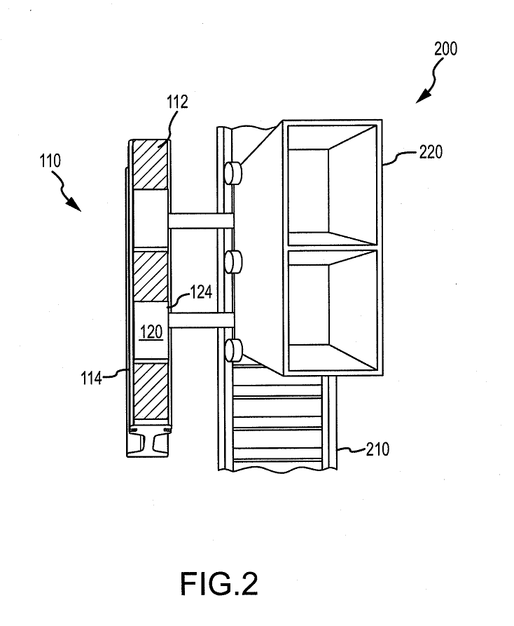

In one embodiment, and with reference now to FIG. 2, the conductor bar 110 may be used with a railway vehicle 220. The conductor bar 110 includes the thin, conductive wear resistant coating located on the outer surface 114 of the conductor bar 110. The railway vehicle 220 is coupled to at least one contact device 120. The contact device 120 is in electrical communication with both the railway vehicle 220 and the conductor bar 110. As the railway vehicle 220 travels on tracks 210, the contact device 120 travels across, and is in contact with, the conductor bar 110. For example, the outer surface 124 of the at least one contact device 120 is in contact with the thin, conductive wear resistant coating 112 as the railway vehicle 220 travels on tracks 210. The thin, conductive wear resistant coating 112 limits or prevents wear of the outer surface 114 of the conductor bar 110.

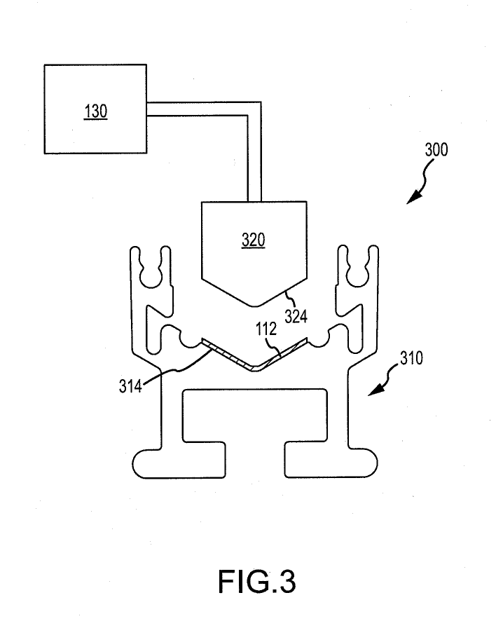

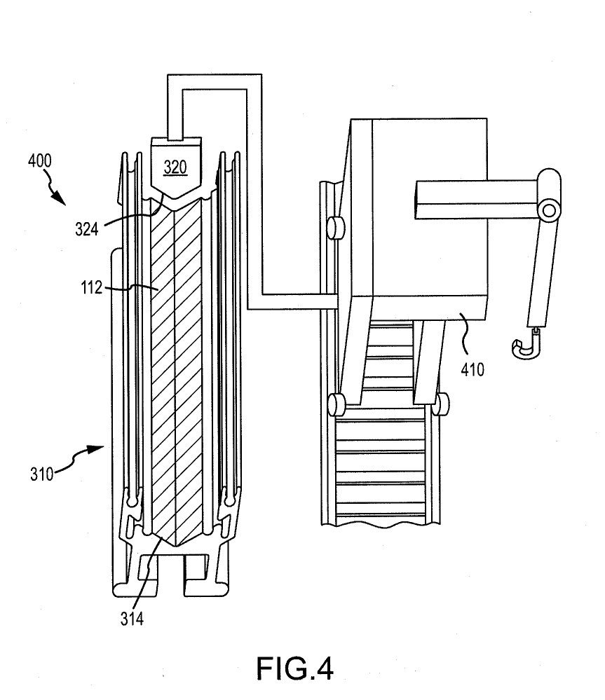

The system 100 may have different configurations such that the system 100 can be used in a variety of applications. For example, and with reference now to FIGS. 3 and 4, the thin, conductive wear resistant coating 112 is located on an outer surface 314 of a conductor bar 310. A contact device 320 may be coupled to the mobile unit 130 and is in electrical communication with both the mobile unit 130 and the conductor bar 310. The contact device 320 may be configured to travel across, and is in contact with, the conductor bar 310 coincidental to movement of the mobile unit 130. In one embodiment, the conductor bar 310 may be used with a crane 410. The crane 410 is coupled to the contact device 320 and the contact device 320 is in electrical communication with both the crane 410 and the conductor bar 310. As the crane 410 moves, the outer surface 324 of the contact device 320 is in contact with the thin, conductive wear resistant coating 112 of the conductor bar 310. The thin, conductive wear resistant coating 112 limits or prevents wear of the outer surface 314 of the conductor bar 310.

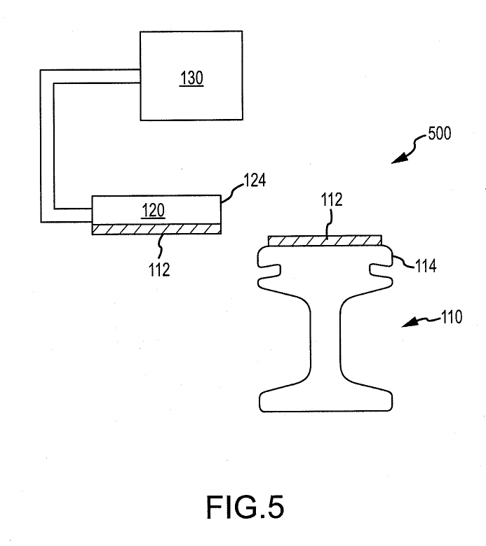

To further facilitate wear resistance, the contact device 120 may also/alternatively include a thin, conductive wear resistant coating on its outer surface 124. For example, and with reference now to FIG. 5, the thin, conductive wear resistant coating 112 is located on the outer surface 124 of the contact device 120. In one embodiment, the thin, conductive wear resistant coating 112 restricts abrading of the outer surface 124 of the contact device 120. In one embodiment, the thin, conductive wear resistant coating 112 may limit or prevent wear of the outer surface 124 of the contact device 120 (e.g., removal of a portion of the outer surface 124 of the contact device 120) due to the movement of the contact device 120, as the contact device 120 travels across the outer surface 114 of the conductor bar 110. The contact device 320, illustrated in FIGS. 3 and 4, may also/alternatively include a thin, conductive wear resistant coating on its outer surface 324 (not illustrated).

Other configurations and/or permutations of wear resistant transportation systems may be used in a variety of applications. For example, a conductor bar is any bar suitable to transmit electric current and suited for use with a contact device. For example, a conductor bar made of aluminum may be used to supply electric current to mobile units via a contact device. A contact device may be any material (e.g., carbon and/or metal) suitable to collect and transmit current and that travels across, and is in contact with, a thin, conductive wear resistant coating of the conductor bar located on an outer surface of the conductor bar. For example, a contact device may contact the outer surface of the conductor bar during operation of a mobile unit, which may facilitate flow of electric current from the conductor bar to the mobile unit. A mobile unit may be any unit capable of moving readily. For example, a mobile unit may be a tram car, metro car, train, crane, trolley, hoist and/or people mover that runs in a subway, tramway, light rail, monorail, amusement park and/or manufacturing facility, to name a few.

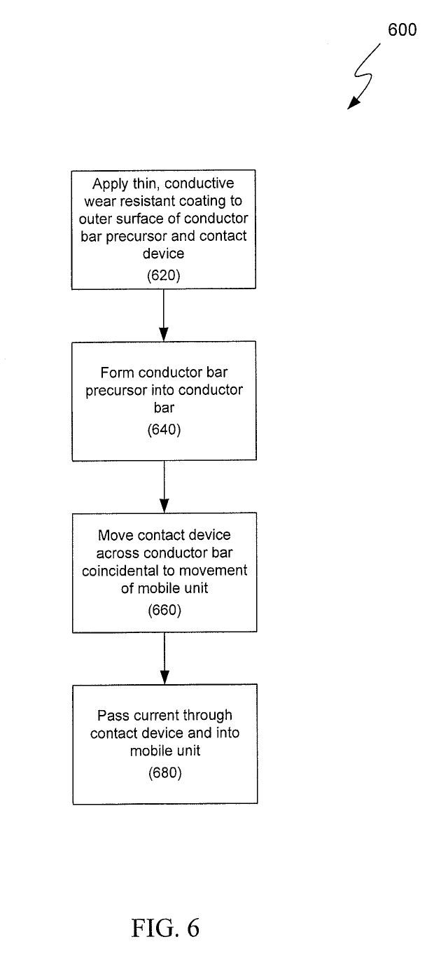

Methods of producing wear resistant transportation systems are also provided. In one embodiment, and with reference to FIG. 6, the method 600 includes the steps of applying a thin, conductive wear resistant coating to an outer surface of at least one of a conductor bar precursor and a contact device (620), forming the conductor bar precursor into a conductor bar (640), moving the contact device across the conductor bar coincidental to the movement of a mobile unit from a first location to a second location (660), and passing current through the contact device and into the mobile unit (680). The passing step (680) is concomitant to the moving step (660). During the moving step (660) and passing step (680), the thin, conductive wear resistant coating restricts abrading of the outer surface of at least one of the conductor bar and the contact device. In one embodiment, the thin, conductive wear resistant coating may be applied via thermal spray and/or cold spray technology.

While various embodiments of the present invention have been described in detail, it is apparent that modifications and adaptations of those embodiments will occur to those skilled in the art. However, it is to be expressly understood that such modifications and adaptations are within the spirit and scope of the present invention.

What is claimed is:

1. A system comprising:
(a) a mobile unit configured to move from a first location to a second location;
(b) a conductor bar;
(c) a contact device coupled to the mobile unit and in electrical communication with both the conductor bar and the mobile unit;
wherein the contact device is configured to travel across, and is in contact with, the conductor bar coincidental to movement of the mobile unit; and
(d) a thin, conductive wear resistant coating located on an outer surface of at least one of the conductor bar and the contact device, wherein the thin, conductive wear resistant coating restricts abrading of the outer surface of at least one of the conductor bar and the contact device.

2. The system of claim 1, wherein the thin, conductive wear resistant coating has a resistivity of not greater than about 30×10⁻⁶ Ω*in/in².

3. The system of claim 1, wherein the thin, conductive wear resistant coating has a thickness of not greater than about 0.040 inch.

4. The system of claim 1, wherein the conductor bar having a thin, conductive wear resistant coating on at least a portion of its outer surface has a surface roughness from about 12μ-inch Rₐ to about 50μ-inch Rₐ.

5. The system of claim 1, wherein the conductor bar having a thin, conductive wear resistant coating on at least a portion of its outer surface has a surface flatness of not greater than about 0.002 inch.

6. The system of claim 1, wherein the thin, conductive wear resistant coating limits direct physical contact between the outer surface of the conductor bar and the contact device.

7. The system of claim 1, wherein the thin, conductive wear resistant coating is located on an outer surface of the conductor bar, and wherein the thin, conductive wear resistant coating limits wear of the outer surface of the conductor bar due to movement of the contact device as the contact device travels across the outer surface of the conductor bar.

8. The system of claim 1, wherein the thin, conductive wear resistant coating is located on an outer surface of the contact device, and wherein the thin, conductive wear resistant coating limits wear of the outer surface of the contact device due to movement of the contact device as the contact device travels across the outer surface of the conductor bar.

9. The system of claim 1, wherein the conductor bar having a thin, conductive wear resistant coating on at least a portion of its outer surface has an electrical resistance of not greater than 30μΩ.

10. The system of claim 1, wherein the conductor bar having a thin, conductive wear resistant coating on at least a portion of its outer surface has a coefficient of thermal expansion of not greater than about 23 in/in/° F. at a temperature from about 68° F. to about 212° F.

11. The system of claim 1, wherein the thin, conductive wear resistant coating sustains arcing due to intermittent contact between the contact device and the conductor bar as the contact device travels across the outer surface of the conductor bar.

12. The system of claim 1, wherein the thin, conductive wear resistant coating comprises at least one of stainless steel and copper.

13. A method comprising:
applying a thin, conductive wear resistant coating to an outer surface of at least one of a conductor bar precursor and a contact device;
forming the conductor bar precursor into a conductor bar;
moving the contact device across the conductor bar coincidental to the movement of a mobile unit from a first location to a second location; and
passing, concomitant to the moving step, current through the contact device and into the mobile unit, wherein during the moving and passing steps, the thin, conductive wear resistant coating restricts abrading of the outer surface of at least one of the conductor bar and the contact device.

14. The method of claim 13, wherein the thin, conductive wear resistant coating is located on the outer surface of the conductor bar.

15. The method of claim 14, wherein the thin, conductive wear resistant coating is crack-free before the forming step.

16. The method of claim 15, wherein the thin, conductive wear resistant coating is crack-free after the forming step.

17. An apparatus comprising:
(a) a conductor bar configured to supply electric current to a mobile unit via a contact device;
wherein the contact device is configured to travel across, and is in contact with, the conductor bar coincidental to movement of the mobile unit; and
(b) a thin, conductive wear resistant coating located on an outer surface of the conductor bar, wherein the thin, conductive wear resistant coating restricts the contact device from abrading the outer surface of the conductor bar.

18. The apparatus of claim 17, wherein the thin, conductive wear resistant coating limits direct physical contact between the outer surface of the conductor bar and the contact device.

19. The apparatus of claim 18, wherein the thin, conductive wear resistant coating comprises at least one of stainless steel and copper.

20. The system of claim 18, wherein the thin, conductive wear resistant coating has a thickness of not greater than about 0.040 inch.
